(19) United States
(12) Patent Application Publication
(10) Pub. No.: US 2021/0125066 A1
(43) Pub. Date: Apr. 29, 2021

(54) QUANTIZED ARCHITECTURE SEARCH FOR MACHINE LEARNING MODELS

(71) Applicant: Lightmatter, Inc., Boston, MA (US)

(72) Inventor: Tomo Lazovich, Cambridge, MA (US)

(73) Assignee: Lightmatter, Inc., Boston, MA (US)

(21) Appl. No.: 17/081,841

(22) Filed: Oct. 27, 2020

Related U.S. Application Data
(60) Provisional application No. 62/926,895, filed on Oct. 28, 2019.

(51) Int. Cl. G06N 3/08; G06N 3/04; G06N 3/067; G06K 9/62

(52) U.S. Cl. CPC G06N 3/08; G06K 9/6256; G06N 3/0675; G06N 3/04

(57) ABSTRACT

Described herein are techniques for determining an architecture of a machine learning model that optimizes the machine learning model. The system obtains a machine learning model configured with a first architecture of a plurality of architectures. The machine learning model has a first set of parameters. The system determines a second architecture using a quantization of the parameters of the machine learning model. The system updates the machine learning model to obtain a machine learning model configured with the second architecture.

### RELATED APPLICATIONS

This application is a Non-Provisional of and claims priority under 35 U.S.C. § 119 (e) to U.S. Application Ser. No. 62/926,895, filed Oct. 28, 2019, entitled “QUANTIZED DIFFERENTIABLE ARCHITECTURE SEARCH FOR NEURAL NETWORKS”, which is incorporated by reference herein in its entirety.

### FIELD

This application relates generally to optimizing an architecture of a machine learning model (e.g., a neural network). For example, techniques described herein may be used to determine an architecture of a machine learning model that optimizes performance of the machine learning model for a set of data.

### BACKGROUND

A machine learning model may have a respective architecture. For example, architecture of a neural network may be determined by a number and type of layers and/or a number of nodes in each layer. The architecture of the machine learning model may affect performance of the machine learning model for a set of data. For example, the architecture of the neural network may affect its classification accuracy for a task. A machine learning model may be trained using a set of training data to obtain a trained machine learning model.

### SUMMARY

According to one aspect, a method of determining an architecture of a machine learning model that optimizes the machine learning model is provided. The method comprises: using a processor to perform: obtaining the machine learning model configured with a first architecture of a plurality of architectures, the machine learning model comprising a first set of parameters; determining a second architecture of the plurality of architectures using a quantization of the first set of parameters; and updating the machine learning model to obtain the machine learning model configured with the second architecture.

According to one embodiment, the method comprises obtaining the quantization of the first set of parameters. According to one embodiment, each of the first set of parameters is encoded with a first representation; and obtaining the quantization of the first set of parameters comprises, for each of the first set of parameters, transforming the parameter to a second number representation.

According to one embodiment, determining the second architecture using the quantization of the first set of parameters comprises: determining an indication of an architecture gradient using the quantization of first set of parameters; and determining the second architecture using the indication of the architecture gradient. According to one embodiment, determining the indication of the architecture gradient for the first architecture comprises determining a partial derivative of a loss function using the quantization of the first set of parameters.

According to one embodiment, the method comprises updating the first set of parameters of the machine learning model to obtain a second set of parameters. According to one embodiment, updating the first set of parameters comprises using gradient descent to obtain the second set of parameters.

According to one embodiment, the method comprises encoding an architecture of the machine learning model as a plurality of weights for respective architecture parameters, the architecture parameters representing the plurality of architectures. According to one embodiment, determining the second architecture comprises determining an update to at least some weights of the plurality of weights; and updating the machine learning model comprises applying the update to the at least some weights.

According to one embodiment, determining the second architecture using the quantization of the first set of parameters comprises: combining each of the first set of parameters with a respective quantization of the parameter to obtain a set of blended parameter values; and determining the second architecture using the set of blended parameter values. According to one embodiment, combining the parameter with the quantization of the parameter comprises determining a linear combination of the parameter and the quantization of the parameter.

According to one embodiment, the machine learning model comprises a neural network. According to one embodiment, the neural network comprises a convolutional neural network. According to one embodiment, the neural network comprises a recurrent neural network. According to one embodiment, the neural network comprises a transformer neural network. According to one embodiment, the first set of parameters comprises a first set of neural network weights.

According to one embodiment, the method comprises training the machine learning model configured with the second architecture to obtain a trained machine learning model configured with the second architecture. According to one embodiment, the method comprises quantizing parameters of the trained machine learning model configured with the second architecture to obtain a machine learning model with quantized parameters. According to one embodiment, the processor has a first word size and the method further comprises transmitting the machine learning model with quantized parameters to a device comprising a processor with a second word size, wherein the second word size is smaller than the first word size.

According to another aspect, a system for determining an architecture of a machine learning model that optimizes the machine learning model is provided. The system comprises: a processor; a non-transitory computer-readable storage medium storing instructions that, when executed by the processor, cause the processor to perform a method comprising: obtaining the machine learning model configured with a first one of a plurality of architectures, the machine learning model comprising a first set of parameters; determining a second one of the plurality of architectures using a quantization of the first set of parameters; and updating the machine learning model to obtain the machine learning model configured with the second architecture.

According to another aspect, a non-transitory computer-readable storage medium storing instructions is provided. The instructions, when executed by a processor, cause the processor to perform a method comprising: obtaining a machine learning model configured with a first one of a plurality of architectures, the machine learning model comprising a first set of parameters; determining a second architecture the plurality of architectures using a quantization of the first set of parameters; and updating the machine learning model to obtain the machine learning model configured with the second architecture.

According to another aspect, a method performed by a device is provided. The method comprises using a processor to perform: obtaining a set of data; generating, using the set of data, an input to a trained machine learning model configured with an architecture selected from a plurality of architectures, wherein the architecture is selected from the plurality of architectures using a quantization of at least some parameters of the machine learning model; and providing the input to the trained machine learning model to obtain an output.

According to one embodiment, the processor has a first word size and the trained machine learning model is obtained by training a machine learning model using a processor with a second word size. According to one embodiment, the first word size is smaller than the second word size. According to one embodiment, the first word size is 8 bits. According to one embodiment, the processor comprises a photonic processor.

According to one embodiment, the trained machine learning model comprises a neural network. According to one embodiment, the neural network comprises a convolutional neural network. According to one embodiment, the neural network comprises a recurrent neural network. According to one embodiment, the neural network comprises a transformer neural network.

According to another aspect, a device is provided. The device comprises: a processor; a non-transitory computer-readable storage medium storing instructions that, when executed by the processor, cause the processor to perform a method comprising: obtaining a set of data; generating, using the set of data, an input to a trained machine learning model configured with an architecture selected from a plurality of architectures, wherein the architecture is selected from the plurality of architectures using a quantization of at least some parameters of the machine learning model; and providing the input to the trained machine learning model to obtain an output.

According to one embodiment, the processor has a first word size and the trained machine learning model is obtained by training a machine learning model using a processor with a second word size. According to one embodiment, the first word size is smaller than the second word size. According to one embodiment, the first word size is 8 bits. According to one embodiment, the processor comprises a photonics processing system.

According to one embodiment, the trained machine learning model comprises a neural network. According to one embodiment, the neural network comprises a convolutional neural network. According to one embodiment, the neural network comprises a recurrent neural network. According to one embodiment, the neural network comprises a transformer neural network.

According to another aspect, a non-transitory computer-readable storage medium storing instructions is provided. The instructions, when executed by a processor, cause the processor to perform a method comprising: obtaining a set of data; generating, using the set of data, an input to a trained machine learning model configured with an architecture selected from a plurality of architectures, wherein the architecture is selected from the plurality of architectures using a quantization of at least some parameters of the machine learning model; and providing the input to the trained machine learning model to obtain an output.

According to one embodiment, the processor has a first word size and the trained machine learning model is obtained by training a machine learning model using a processor with a second word size, wherein the first word size is smaller than the second word size.

### BRIEF DESCRIPTION OF THE DRAWINGS

Various aspects and embodiments will be described herein with reference to the following figures. It should be appreciated that the figures are not necessarily drawn to scale. Items appearing in multiple figures are indicated by the same or a similar reference number in all the figures in which they appear.

FIG. 1 shows an environment in which various embodiments of the technology described herein may be implemented.

FIG. 2 shows an illustration of an example environment in which various embodiments of the technology described herein may be implemented.

FIG. 3 shows a flowchart of an example process for determining an optimal architecture of a machine learning model, according to some embodiments of the technology described herein.

FIG. 4 shows a flowchart of an example process for updating an architecture of a machine learning model, according to some embodiment of the technology described herein.

FIG. 5 shows a flowchart of an example process for updating parameters of a machine learning model, according to some embodiments of the technology described herein.

FIG. 6 shows a flowchart of an example process for quantizing parameters of a machine learning model, according to some embodiments of the technology described herein.

FIG. 7 shows a flowchart of an example process for providing a machine learning model with quantized parameters, according to some embodiments of the technology described herein.

FIG. 8 shows a block diagram of an example computer system, according to some embodiments of the technology described herein.

FIG. 9 shows a schematic diagram of an example photonic processing system, according to some embodiments of the technology described herein.

### DETAILED DESCRIPTION

A trained machine learning model may include learned parameters that are stored in a memory of a device that uses the machine learning model. When the device uses the machine learning model (e.g., to process an input to the machine learning model), the device executes computations using the parameters to obtain an output from the machine learning model. Accordingly, the device requires resources to store the parameters of the machine learning model, and to execute the computations (e.g., mathematical calculations) using the parameters. For example, a neural network for enhancing an image may include many (e.g., hundreds or thousands) of learned parameters (e.g., weights) that are used to process the image. A device that uses the neural network model may store the weights of the neural network in memory of the device, and use the weights to process an input (e.g., pixel values of an image to be enhanced) to obtain an output.

In order to improve the efficiency of computations involved in using the machine learning model, the parameters of the machine learning model may be quantized. The device may perform computations with the quantized parameters more efficiently than with the non-quantized parameters. For example, a quantization of a parameter may reduce the number of bits used to represent the parameter and thus computations performed by a processor using the quantized parameter may be more efficient than those performed with the unquantized parameter. In some instances, a device that uses the machine learning model may have more limited computational resources than a computer system used to train the machine learning model. For example, the device may have a processor with a first word size while the training system may have a processor with a second word size, where the first word size is smaller than the second word size. As an illustrative example, the machine learning model may be trained using a computer system with a 32-bit processor, and then deployed on a device that has an 8-bit processor. The parameters determined by the computer system may be quantized to allow the device to perform computations with the parameters of the machine learning model more efficiently.

Although quantization of parameters of a machine learning model may allow a device to perform computations more efficiently, it reduces the performance of the machine learning model due to the information loss from the quantization. For example, quantization of parameters of a machine learning model may reduce the classification accuracy of the machine learning model. Accordingly, the inventors have developed techniques that reduce the loss in performance of the machine learning model resulting from quantization.

One factor that affects performance of a machine learning model in performing a task is the architecture selected for the machine learning model. For example, an architecture of a neural network may affect the performance of the neural network for a task. The inventors have recognized that conventional architecture search techniques do not account for quantization of parameters. Accordingly, the inventors have developed techniques for determining an architecture of a machine learning model that integrate quantization of parameters of the machine learning model. By integrating the quantization of the parameters, the techniques may provide a machine learning model architecture that reduces the loss in performance resulting from quantization of parameters of the machine learning model. The techniques may determine an architecture that optimizes the machine learning model for quantization of parameters of the machine learning model.

According to some embodiments, a system may perform an iterative architecture search to determine an optimal architecture of a machine learning model from a search space of architectures. The system obtains a machine learning model configured with an architecture from the search space of architectures. At each iteration, the system updates the architecture of the machine learning model using a quantization of parameters of the machine learning model. The system may repeat these steps until the system converges on an architecture. For example, the system may iterate until the architecture meets a threshold level of performance.

Some embodiments described herein address all the above-described issues that the inventors have recognized with conventional techniques of quantization. However, it should be appreciated that not every embodiment described herein addresses every one of these issues. It should also be appreciated that embodiments of the technology described herein may be used for purposes other than addressing the above-discussed issues of quantization.

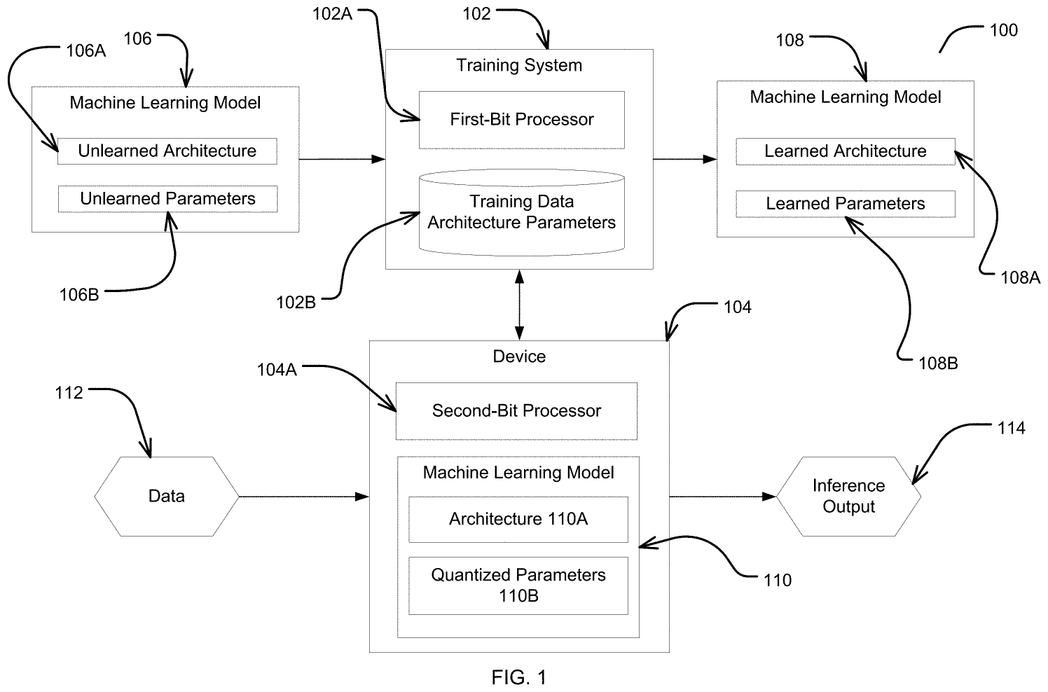

FIG. 1 shows an environment 100 in which various embodiments of the technology described herein may be implemented. The environment 100 includes a training system 102 and a device 104.

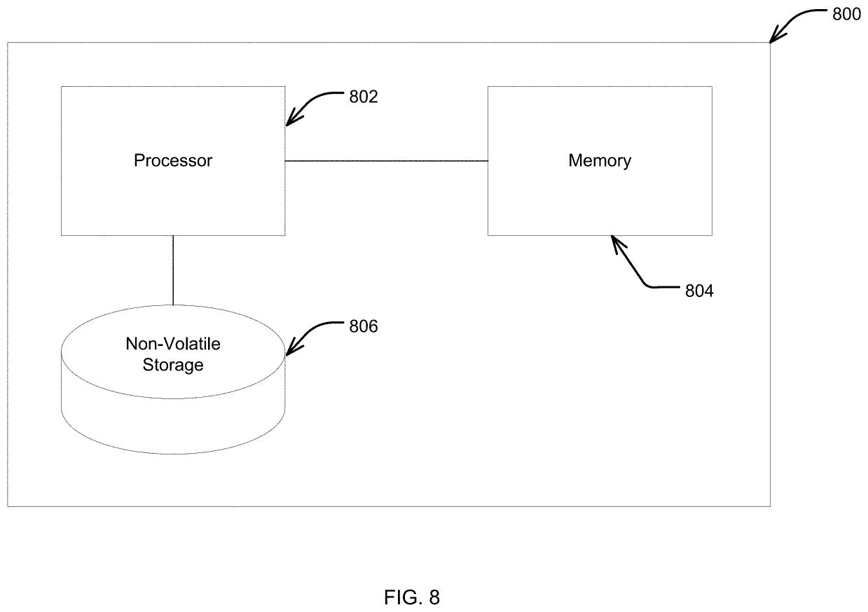

The training system 102 may be a computer system. For example, the training system 102 may be a computer system as described herein with reference to FIG. 8. The training system 102 may be configured to determine an architecture of a machine learning model (e.g., machine learning model 106). In some embodiments, the training system 102 may be configured to determine the architecture of the machine learning model by selecting the architecture from a search space of architectures that the machine learning model may be configured with. The training system 102 may be configured to select the architecture that optimizes the machine learning model. For example, the system 102 may select the architecture that optimizes performance of the machine learning model for a task. In some embodiments, the training system 102 may be configured to automatically select the architecture that optimizes the machine learning model for a set of data representative of a task.

As shown in the example embodiment of FIG. 1, the training system 102 includes a processor 102A having a word size of a first number of bits. For example, the processor 102A may have a word size of 4 bits, 8 bits, 16 bits, 32 bits, 64 bits, or 128 bits. The processor 102A may process up to the first number of bits in a single instruction. Thus, the processor may be able to process up to the first number of bits in a single clock cycle. In one example, the processor 102A may be a 32-bit processor. In this example, the processor 102A may process one or more numbers represented by up to 32 bits in a single instruction. In some embodiments, the processor 102A may be a photonics processor, a microcontroller, a microprocessor, an embedded processor, a digital signals processing (DSP) processor, or any other suitable type of processor. In some embodiments, the processor 102A may be a photonic processing system as described in U.S. patent application Ser. No. 16/412,098, filed on May 14, 2019, entitled “PHOTONIC PROCESSING SYSTEMS AND METHODS,” which is incorporated herein by reference in its entirety.

In some embodiments, the training system 102 may be configured to use the processor 102A to determine an architecture for machine learning model 106 and train parameters of the machine learning model 106 to obtain machine learning model 108. The machine learning model 106 may have an unlearned architecture 106A and unlearned parameters 106B. The training system 102 may be configured to (1) determine an architecture for the machine learning model 106 that optimizes the machine learning model (e.g., for a task); and (2) train machine learning model 106 configured with the determined architecture to learn parameters for the machine learning model 106. The trained machine learning model 108 may include a learned architecture 108A and learned parameters 108B determined by the training system 102. In some embodiments, the training system 102 may be configured to determine an architecture of the machine learning model 106 that optimizes the machine learning model 106 for a task. For example, the machine learning model 106 may be a neural network model for use in enhancing images. In this example, the training system 102 may determine an architecture of the neural network that optimizes the enhancement provided by the neural network.

As shown in the example embodiment of FIG. 1, the training system 102 includes storage 102B. In some embodiments, the storage 102B may be memory of the training system 102. For example, the storage 102B may be a hard drive (e.g., solid state hard drive, and/or hard disk drive) of the training system 102. In some embodiments, the storage 102B may be external to the training system 102. For example, the storage 102B may be a database server from which the training system 102 may obtain data. The training system 102 may be configured to access the external storage 102B via a network (e.g., the Internet).

As shown in the example embodiment of FIG. 1, the storage 102B stores training data and architecture parameters. The training system 102 may be configured to use the training data to train the machine learning model 106. For example, the training data may include input data and corresponding output data. The training system 102 may apply supervised learning techniques to the training data to train the machine learning model 106. In another example, the training data may include input data. The training system 102 may apply unsupervised learning techniques to the training data to train the machine learning model 106. In some embodiments, the training system 102 may be configured to use the training data to determine an optimal architecture of a machine learning model (e.g., machine learning model 106).

In some embodiments, the architecture parameters may indicate respective architectural components that may be used to construct the architecture of the machine learning model 106. In some embodiments, the architecture parameters may represent a search space of possible architectures that the machine learning model 106 can be configured with. For example, for a convolutional neural network (CNN), the architecture parameters may be a set of candidate operations that can be performed at each layer of the CNN. In some embodiments, the architecture parameters may be parameterized by a set of weights, where each weight is associated with a respective architecture parameter that can be used to construct the architecture of the machine learning model. In some embodiments, the training system 102 may store the weights in a vector, matrix, or other tensor indicating the weights. The training system 102 may be configured to make the search space of architectures continuous using the weights. The training system 102 may be configured to determine an output of the machine learning model by: (1) determining an output using each architecture parameter; and (2) combining the outputs according to the weights for the architecture parameters. For example, the training system 102 may determine an output of the machine learning model to be a linear combination of the output obtained using each architecture parameter. The training system 102 may be configured to optimize the weights to determine the architecture parameters that optimize the machine learning model. For example, the training system 102 may optimize the weights using stochastic gradient descent. The training system 102 may be configured to identify a discrete weight from the optimized weights by selecting one or more architecture parameters that have the greatest associated weights.

As an illustrative example, the machine learning model 106 may be a convolutional neural network (CNN). The architecture parameters may be candidate operations for layers of the CNN. For example, the architecture parameters may be a set of candidate operations (e.g., convolution, a max pooling, and/or activation) that can be applied at each layer of the CNN. In this example, the training system 102 may parameterize the architecture space with a matrix indicating weights for each candidate operation at each layer of the CNN. The training system 102 may then determine an optimal architecture for the CNN by optimizing the weights for the candidate operations (e.g., using stochastic gradient descent). The training system 102 may then select the optimal architecture by selecting the candidate operation for each layer with the highest associated weight.

In some embodiments, the training system 102 may be configured to select an architecture of a machine learning model from multiple architectures by performing an architecture search over the architectures. The training system 102 may be configured to perform an architecture search by: (1) obtaining a machine learning model configured with a first architecture; (2) determining a second architecture from the multiple architectures; and (3) updating the machine learning model to obtain a machine learning model configured with the second architecture. The system may be configured to iterate these steps until an optimal architecture is identified.

In some embodiments, the training system 102 may be configured to use stochastic gradient descent to update an architecture of the machine learning model in each iteration. For example, the training system 102 may update weights for respective architecture parameters using stochastic gradient descent until the weights converge. The training system 102 may be configured to: (1) determine an indication of an architecture gradient for a first architecture that the machine learning model is configured with; and (2) determine a second architecture using the indication of the architecture gradient. In some embodiments, the indication of the architecture gradient may be an approximation of an actual architecture gradient. Example indications of an architecture gradient are described herein. In some embodiments, the training system 102 may be configured to determine an indication of an architecture gradient using a measure of performance of the machine learning model. In some embodiments, the training system 102 may be configured to use a loss function as a measure of performance of the machine learning model. For example, the loss function may be a mean square error function, quadratic loss function, L2 loss function, mean absolute error function, L1 loss function, cross entropy loss function, or any other suitable loss function. In some embodiments, the training system 102 may be configured to incorporate a cost function into the loss function. For example, the training system 102 may incorporate a cost function to incorporate hardware constraints of a device (e.g., device 104) that will use the machine learning model.

In some embodiments, the training system 102 may be configured to integrate quantization of parameters of a machine learning model into an iterative architecture search. The parameters of the machine learning model may be parameters internal to the machine learning model, and are distinct from the architecture parameters. The parameters of the machine learning model may be determined using training data (e.g., by applying a supervised or unsupervised learning technique to the training data). For example, the parameters of a neural network may include weights of the neural network. In some embodiments, the training system 102 may be configured to integrate quantization of the parameters into an architecture search by using a quantization of parameters to determine an updated architecture in an iteration of the architecture search. In some embodiments, the training system 102 may be configured to integrate the quantization of parameters by using the quantization of the parameters to determine an indication of an architecture gradient. The training system 102 may be configured to use the indication of the architecture gradient obtained using the quantization of the parameters to determine another architecture. For example, the training system 102 may, in an iteration of the architecture search: (1) determine an indication of an architecture gradient using a quantization of parameters of the machine learning model 106; and (2) update the machine learning model using the indication of the architecture gradient.

In some embodiments, the training system 102 may be configured to determine an indication of an architecture gradient using a quantization of parameters by using the quantization of parameters to update parameters of the machine learning model. For example, the training system 102 may use quantized parameters to: (1) determine a gradient of the parameters; and (2) update the parameters by descending the parameters by a proportion of the gradient. The training system 102 may be configured to use the updated parameters of the machine learning model to determine the indication of the architecture gradient. The training system 102 may be configured to update the parameters of the machine learning model in order to approximate the optimal parameters for each architecture using a single training step. By using this approximation, the training system 102 may avoid training the machine learning model to determine an optimal set of parameters at each iteration of an architecture search.

In some embodiments, the training system 102 may be configured to (1) configure the machine learning model 106 with a determined architecture; and (2) train the machine learning model 106 configured with the architecture using training data to obtain the machine learning model 108 with learned architecture 108A and learned parameters 108B. The architecture 108A may be optimized for a particular set of data. For example, the training data used by the training system 102 may be representative of a particular task (e.g., image enhancement) that the machine learning model 108 is trained to perform. In some embodiments, the training system 102 may be configured to deploy the machine learning model 108 to another device (e.g., device 104) for use by the device. For example, the machine learning model 108 may be a neural network model for image enhancement that the training system 102 deploys to a smartphone for use in enhancing images captured by a digital camera of the smartphone.

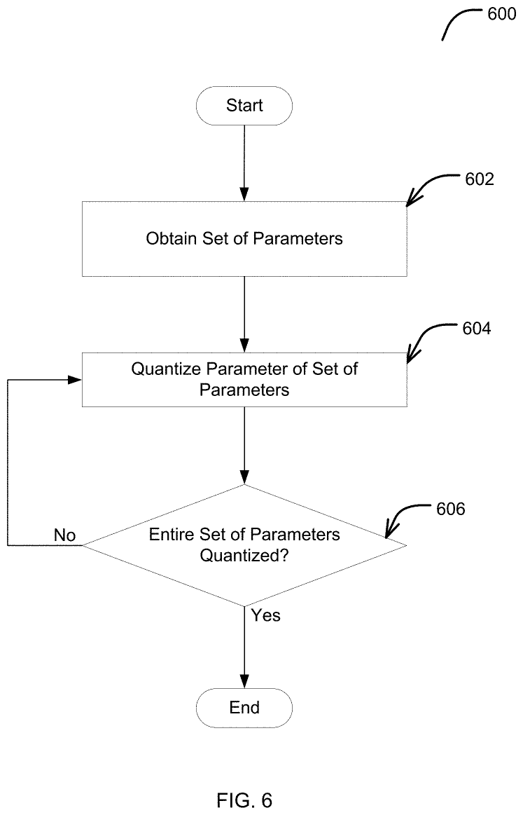

In some embodiments, the training system 102 may be configured to quantize the learned parameters 108B. In some embodiments, the training system 102 may be configured to quantize the parameters 108B by transforming the parameters 108B from a first representation to a second representation. For example, training system 102 may convert the learned parameters 108B from 32-bit representation to an 8-bit representation. In another example, the training system 102 may convert the learned parameters 108B from a 32-bit floating point value to an 8-bit integer value. An example process for quantization is described herein with reference to FIG. 6. In some embodiments, the training system 102 may be configured to quantize the learned parameters 108B according to hardware of a device. For example, the training system 102 may be configured to quantize the learned parameters 108B according to a word size of a processor of the device on which the machine learning model 108 is to be deployed.

In some embodiments, the machine learning models 106 may be a neural network. In some embodiments, the neural network may be a convolutional neural network, a recurrent neural network, a transformer neural network, or any other type of neural network. In some embodiments, the machine learning model may be a support vector machine (SVM), a decision tree, Naïve Bayes classifier, or any other suitable machine learning model.

As shown in the example embodiment of FIG. 1, the environment 100 includes a device 104. The device 104 may be a computing device. For example, the device 104 may be a computing device as described herein with reference to FIG. 8. For example, the device 104 may be a mobile device (e.g., a smartphone), a camera, or any other computing device.

As shown in the example embodiment of FIG. 1, the device 104 includes a processor 104A having a word size of a second number of bits. For example, the processor 104A may have a word size of 4 bits, 8 bits, 16 bits, 32 bits, 64 bits, or 128 bits. The processor 104A may process up to the second number of bits in a single instruction. Thus, the processor may be able to process up to the second number of bits in a single clock cycle. In one example, the processor 104A may be an 8-bit processor. In this example, the processor 104A may process one or more numbers represented by up to 8 bits in a single instruction. In some embodiments, the processor 102A may be an optical computing processor, photonic processor, microcontroller, a microprocessor, an embedded processor, a digital signals processing (DSP) processor, or any other suitable type of processor. In some embodiments, the processor 102A may be a photonic processing system as described in U.S. patent application Ser. No. 16/412,098 filed on May 14, 2019, entitled “PHOTONIC PROCESSING SYSTEMS AND METHODS.”

In some embodiments, the word size of the processor 104A of the device 104 may be smaller than the word size of the processor 102A of the training system 102. For example, the word size of the processor 104A may be 8 bits and the word size of the processor 102A may be 32 bits. In this example, the processor 104A may perform computations involving data (e.g., numbers) represented by greater than 8 bits less efficiently than the processor 102A.

As shown in the example embodiment of FIG. 1, the device 104 includes a machine learning model 110. The machine learning model 110 includes an architecture 110A and quantized parameters 110B. In some embodiments, the architecture 110A may be determined by the training system 102. In some embodiments, the training system 110 may be configured to obtain machine learning model 110 by quantizing the parameters 108B of the trained machine learning model 108 to obtain the machine learning model 110. Thus, the architecture 110A may be the architecture 108A determined by the training system 102 (e.g., to optimize the machine learning model 108 for a task). For example, the learned parameters 108B may be 32-bit floating point values and the quantized parameters 110B may be 8-bit integer representations of the 32-bit values. The quantized parameters 110B may allow the device 104 to perform computations with parameters of the machine learning model 110 more efficiently than with the unquantized parameters 108B.

As shown in the example embodiment of FIG. 1, the device 104 receives input data 112 and generates an inference output 114. In some embodiments, the device 104 may be configured to use the machine learning model 110 to determine the output 114. The device 104 may be configured to generate input to the machine learning model 110 using the data 112. For example, the device 104 may determine one or more features and provide the feature(s) as input to the machine learning model 110 to obtain the inference output 114. As an illustrative example, the machine learning model 110 may be a neural network for use in enhancing images obtained by the device 104. In this example, the data 112 may be pixel values of an image. The device 104 may use the pixel values of the image to generate input to the machine learning model 110. The device 104 may provide the generated input to the machine learning model 110 to obtain an output indicating an enhanced image.

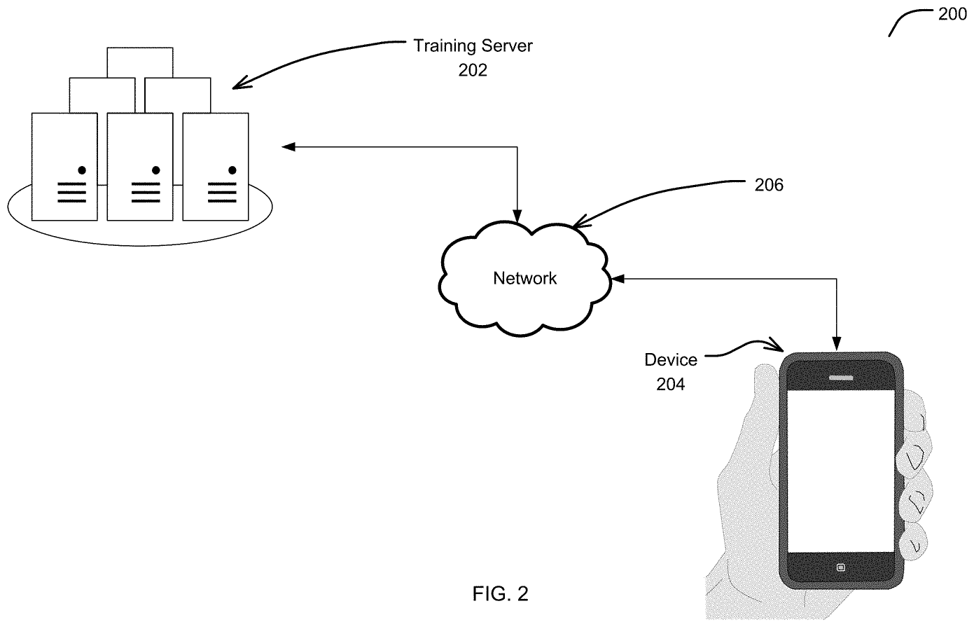

FIG. 2 shows an illustration of an example environment 200 in which various embodiments of the technology described herein may be implemented. The environment 200 includes a training server 202, a device 204, and a network 206.

In some embodiments, the training server 202 may be a computer system for training a machine learning model. For example, the training system 102 described herein with reference to FIG. 1 may be implemented on the training server 202. The training server 202 may be configured to train a machine learning model, and transmit the trained machine learning model through network 206 to the device 204. In some embodiments, the training server 202 may be configured to determine an architecture of the machine learning model that optimizes the machine learning model. For example, the training server 202 may determine the architecture of the machine learning model that optimizes performance of the machine learning model to perform a task (e.g., enhance images captured by a camera of device 204). In some embodiments, the training server 202 may be configured to integrate quantization of parameters into determination of the architecture of the machine learning model that optimizes the machine learning model.

In some embodiments, the training server 202 may be configured to: (1) train a machine learning model; (2) quantize parameters of the machine learning model; and (3) provide the machine learning model with quantized parameters to the device 204. For example, the device 204 may be a smartphone with more constrained computational resources than those of the training server 202. For example, the smartphone may have an 8-bit processor while the training server has a 32-bit processor. The training server 202 may provide a machine learning model with quantized parameters to improve the efficiency of the smartphone 204 when using the machine learning model.

As shown in FIG. 2, the environment 200 includes a network 206. the network 206 of FIG. 2 may be any network through which the training server 202 and the device 204 can communicate. In some embodiments, the network 206 may be the Internet, a local area network (LAN), a wide area network (WAN), a cellular network, an ad hoc network, and/or any other suitable type of network, as aspects of the technology described herein are not limited in this respect. In some embodiments, the network 206 may include one or more wired links, one or more wireless links, and/or any suitable combination thereof.

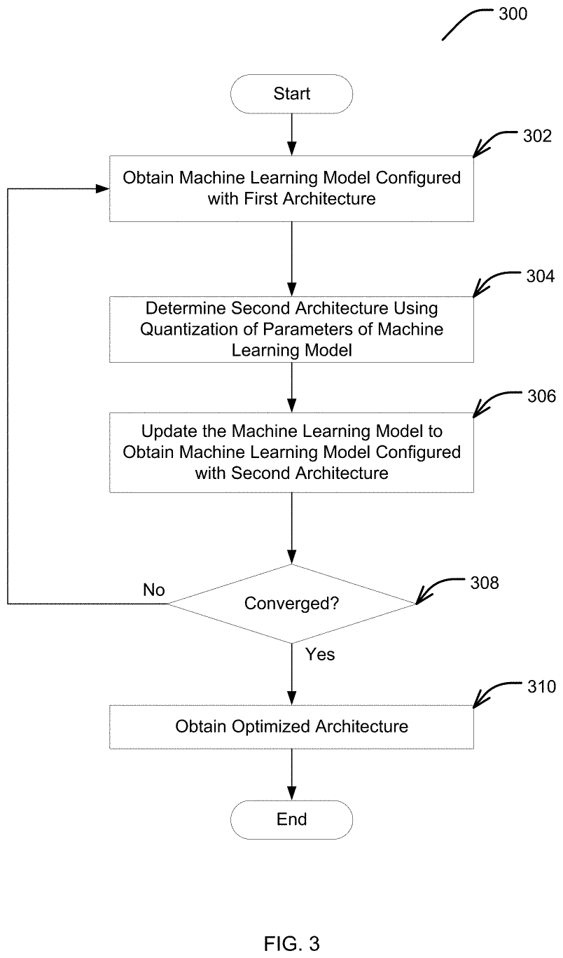

FIG. 3 shows a flowchart of an example process 300 for determining an architecture of a machine learning model, according to some embodiments of the technology described herein. Process 300 may be performed by any suitable computing device. For example, process 300 may be performed by training system 102 described herein with reference to FIG. 1.

Process 300 begins at block 302, where the system obtains a machine learning model configured with a first architecture. In some embodiments, the system may be configured to obtain the machine learning model configured with the first architecture by randomly selecting an architecture from a search space of possible architectures. In some embodiments, the system may be configured to determine an architecture to be a set of one or more architecture parameters that may be used to construct the architecture for the machine learning model. For example, for a convolutional neural network (CNN), the architecture parameters may be a set of candidate operations for each layer of the CNN (e.g., convolution, max pooling, and/or full connected layer).

In some embodiments, the search space of architectures may be parameterized as weights for respective architecture parameters. The system may be configured to determine an output of the machine learning model by using the weights to combine outputs obtained using all the architecture parameters. The weights may thus represent a continuous search space of architectures of the machine learning model. The system may be configured to obtain the machine learning model configured with the first architecture by initializing weights (e.g., indicated by the vector, matrix, or other tensor). For example, the system may initialize all the weights to the same value.

As an illustrative example, the machine learning model may be a convolutional neural network (CNN). The architecture search space of architecture parameters may be candidate operations that can be applied at layers of the CNN. For example, the architecture parameters may be a convolution operation, a max pooling operation, and an activation function. The system may have a vector indicating a weight for each of the candidate operations at each layer of the CNN. The system may initialize the weights indicated by the vector to obtain a CNN with a first architecture. For example, for each layer of the CNN, the system may initialize a vector indicating a weight of 0.25 for a convolution, a weight of 0.25 for a max pooling operation, a weight of 0.25 for an activation function, and a weight of 0.25 for a fully connected layer. In some embodiments, the weights for the architecture parameters may sum to 1.

In some embodiments, the machine learning model may have a set of parameters. For example, where the machine learning model is a CNN, the set of parameters may be filter weights for one or more convolution filters and weights of a fully connected layer. In some embodiments, the system may be configured to initialize the set of parameters. For example, the system may initialize the parameters to random numbers.

Next, process 300 proceeds to block 304, where the system determines a second architecture using a quantization of parameters of the machine learning model. In some embodiments, the system may be configured to quantize the parameters of the machine learning model. For example, the parameters of the machine learning model may be 32-bit floating point values. The system may quantize the parameters by determining 8-bit integer representations of the 32-bit floating point values. An example process for quantizing parameters of a machine learning model is described herein with reference to FIG. 6.

In some embodiments, the system may be configured to determine the second architecture using the quantization of parameters by performing a gradient descent. The system may be configured to: (1) determine an indication of an architecture gradient using the quantization of the parameters; and (2) determine the second architecture using the indication of the architecture gradient. In some embodiments, the system may be configured to determine the indication of the architecture gradient by determining a difference between predicted outputs obtained from the machine learning model configured with the first architecture and expected outputs. The system may be configured to use the determined difference to determine the indication of the architecture gradient. In some embodiments, the system may be configured to evaluate a difference between the predicted outputs and the expected outputs by using a loss function. The system may be configured to determine the indication of the architecture gradient by determining a multi-variable derivative of the loss function with respect to architecture parameters of the search space. For example, the system may determine the indication of the architecture gradient to be a multi-variable derivative of the loss function with respect to a weight for each architecture parameter.

Continuing with the example of a CNN, the system may have a vector indicating a first set of weights for candidate operations at each layer of the CNN. For example, for a respective layer of the CNN, the vector may indicate a first weight for a convolution operation, a second weight for a max pooling operation, and a third weight for a fully connected layer. The system may determine partial derivatives of a loss function with respect to weights for architecture parameters of the CNN. The system may determine a first partial derivative with respect to the first weight for the convolution operation, a second partial derivative with respect to the max pooling operation, and a third partial derivative with respect to the fully-connected layer. The system may use the indication of the architecture gradient to be the partial derivatives.

Next, process 300 proceeds to block 306 where the system updates the machine learning model to obtain a machine learning model configured with the second architecture (e.g., determined at block 304). The system may be configured to update the architecture using the indication of the architecture gradient. In some embodiments, the system may be configured to update the architecture by updating weights for different architecture parameters using the indication of the architecture gradient. For example, the system may update the weights indicated by a vector by descending each weight by a proportion (e.g., 0.1, 0.5, 1.0) of a partial derivative of a loss function with respect to the weight.

In some embodiments, the system may be configured to update parameters of the machine learning model configured with the second architecture. In some embodiments, the system may be configured to update the parameters of the machine learning model by applying a supervised learning technique to training data. For example, the system may update the parameters of the machine learning model using stochastic gradient descent. The system may be configured to update the parameters of the machine learning model by: (1) determining predicted outputs for a set of data (e.g., a training set of data); (2) determining a difference between the predicted outputs and the expected outputs; and (3) updating the parameters based on the difference. For example, the system may determine partial derivatives of a loss function with respect to the parameters and use the partial derivatives to determine a descent for each of the parameters.

Continuing with the example of the CNN, the system may update the CNN to obtain a CNN with a second architecture. For each layer, the system may update a first weight associated with convolution, a second weight associated with max pooling, and a third weight associated with a fully connected layer. The system may update the weights by descending the weights using the indication of the architecture gradient. The system may update parameters of the CNN configured with the second architecture.

Next, process 300 proceeds to block 308 where the system determines whether the architecture has converged. In some embodiments, the system may be configured to determine whether the architecture has converged based on the indication of the architecture gradient. For example, the system may determine that the machine learning model has converged when the system determines that the indication of the architecture gradient is less than a threshold value. In some embodiments, the system may be configured to determine whether the architecture has converged by: (1) evaluating a loss function; and (2) determining whether the value of the loss function is below a threshold value. In some embodiments, the system may be configured to determine whether the architecture has converged by determining whether the system has performed a threshold number of iterations. For example, the system may determine that the architecture has converged when the system has performed a maximum number of iterations.

If the system determines at block 308 that the architecture has not converged, then process 300 proceeds to block 302. The system may repeat blocks 302-308 using the second architecture as the first architecture. If the system determines at block 308 that the architecture has converged, then process 300 proceeds to block 310, where the system obtains the optimized architecture. In some embodiments, the system may be configured to obtain the optimized architecture by selecting one or more architecture parameters from which the architecture of the machine learning model can be constructed. In some embodiments, the system may be configured to select an architecture parameter from a set of architecture parameters by selecting the architecture parameter with the highest associated weight. For example, for each layer of a CNN, the system may select from a set of candidate operations consisting of convolution, max pooling, and fully connected layer based on the weights for the candidate operations. The system may select the operation for the layer having the highest weight. Accordingly, the system may obtain a discrete architecture from the continuous space representation of the candidate architectures.

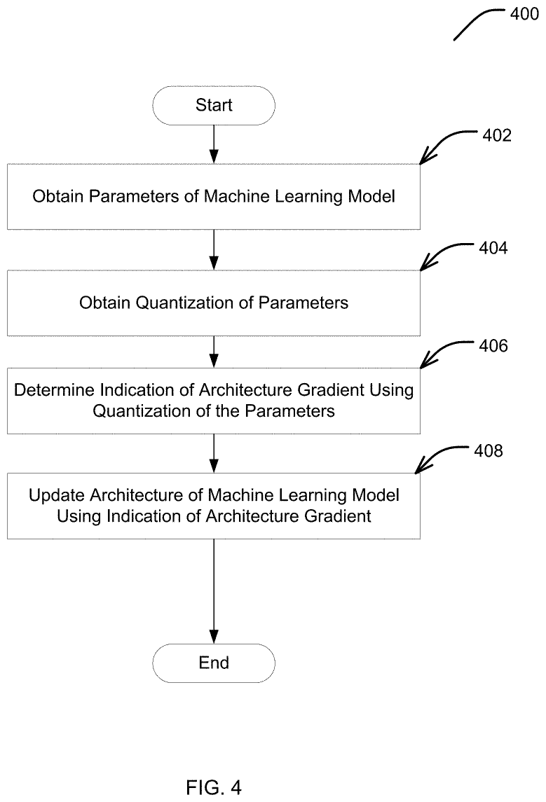

FIG. 4 shows a flowchart of an example process 400 for updating an architecture of a machine learning model, according to some embodiment of the technology described herein. Process 400 may be performed as part of process 300 described herein with reference to FIG. 3. For example, process 400 may be performed at block 306. Process 400 may be performed by any suitable computing device. For example, process 400 may be performed by training system 102 described herein with reference to FIG. 1.

Process 400 begins at block 402, where the system obtains parameters of a machine learning model. For example, the system may obtain the parameters of the machine learning model by initializing parameters of the machine learning model (e.g., at the beginning of an iterative architecture search process such as process 300 described herein with reference to FIG. 3). In another example, the system may obtain the parameters from a previous iteration of an architecture search. For example, the system may obtain the parameters from updating the machine learning model as described at block 306 of process 300.

Next, process 400 proceeds to block 404, where the system obtains a quantization of the parameters of the machine learning model. An example process for obtaining a quantization of parameters of a machine learning model is described herein with reference to FIG. 6. For example, the parameters may have a first representation (e.g., as 32-bit floating point values), and the system may obtain the quantization by transforming the parameters to a second representation (e.g., 8-bit integer).

Next, process 400 proceeds to block 406 where the system determines an indication of an architecture gradient using the quantization of the parameters. In some embodiments, the system may be configured to determine the indication of the architecture gradient by: (1) determining an update to the parameters of the machine learning model using the quantization of the parameters; (2) applying the update to the parameters; and (3) determining the indication of the architecture gradient using the updated parameters. In some embodiments, the system may be configured to determine the indication of the architecture gradient by determining, using the updated parameters, a partial derivative of a loss function with respect to architecture parameters (e.g., with respect to weights associated with the architecture parameters).

In some embodiments, the system may be configured to update the parameters using stochastic gradient descent. The system may be configured to determine a descent for the parameters of the machine learning model using the quantization of the parameters. The system may be configured to: (1) use the quantization of the parameters to determine predicted outputs of the machine learning model; (2) determine a difference between the predicted outputs and expected outputs; and (3) update the parameters of the machine learning model based on the difference. In some embodiments, the system may be configured to evaluate the difference using a loss function. The system may be configured to determine a parameter gradient to be a partial derivative of the loss function with respect to each parameter.

Below is an example equation for use in determining the indication of the architecture according to some embodiments. The system may be configured to determine the indication of the architecture gradient to be equation (1).

∇_{α}Lᵥₐₗ(w−ξ∇_{w}Lₜᵣₐᵢₙ(w_{q},α),α) Equation (1)

In equation (1), α is a current architecture that the machine learning model is configured with, ∇_{α}Lᵥₐₗ is the partial derivative of a loss function with respect to the architecture determined from a validation data set, w is a set of parameters of the machine learning model, w_{q} is a quantization of the parameters of the machine learning model, ∇_{w}Lₜᵣₐᵢₙ(w_{q}, α) is a partial derivative of a loss function with respect to the parameters of the machine learning model configured with the current architecture determined from a training data set, and ξ indicates a learning rate. As shown in the example of equation (1), the system may be configured to determine a descent (ϵ∇_{w}Lₜᵣₐᵢₙ(w_{q}, α)) for the parameters of the machine learning model by determining a partial derivative of a loss function with respect to the parameters using the quantization of the parameters. The system determines the partial derivative of the loss function with respect to the parameters using a training data set. The system may be configured to update the parameters of the machine learning model using the determined descent. The system may then determine the partial derivative of a loss function with respect to architecture parameters using a validation data set to be the indication of the architecture gradient.

In some embodiments, the system may be configured to determine the partial derivatives of the loss function with respect to architecture parameters by determining the partial derivatives with respect to weights for the architecture parameters. For example, the system may parameterize the architecture search space as a set of weights for respective architecture parameters (e.g., indicated by a vector). An architecture may be defined by the weights for the architecture parameters. In the example of a CNN, the architecture parameters may be candidate operations (e.g., convolution, max pooling, and/or activation functions) that may be used in layers of the CNN. For each layer of the CNN, the system may obtain the output of the layer as a linear combination of the outputs obtained from applying each of the candidate operations to the input to the layer. The system may use the weights to determine the combination. For example, the system may multiply the output obtained from each candidate operation by a respective weight, and then add the weighted outputs to obtain the output for the layer.

In some embodiments, the system may be configured to use the quantization of parameters of the machine learning model by blending quantized parameters of the machine learning model with non-quantized parameters. For example, for each parameter of the machine learning model, the system may use a linear combination (a “blending”) of a parameter and a quantization of the parameter to determine predicted outputs of the machine learning model. The inventors have recognized that this may allow the system to converge on an optimal architecture more quickly and/or with higher probability, while still incorporating the quantization of the parameters into the determination of the architecture. Equation (2) shown below shows an example modification to equation (1) that incorporates blending of the parameters of the machine learning model with the quantization of the parameters.

∇_{α}Lᵥₐₗ(w−ξ∇_{w}Lᵣₐᵢₙ(εw_{q}+(1−ε)w,α),α) Equation (2)

In equation (2), the quantization of the parameters has been replaced with a blending of the parameters w and a quantization of the parameters w_{q} as determined by a parameter ε. In some embodiments, the parameter E may be a value between 0 and 1.

In some embodiments, the system may be configured to blend different levels of quantization of the parameters. The system may be configured to blend a first quantization of a parameter with a second quantization of the parameter. For example, the first quantization of the parameter may be a quantization of the parameter into a first number of bits (e.g., 16 bits) and the second quantization of the parameter may be a quantization of the parameters into a second number of bits (e.g., 8 bits). The system may blend the first quantization and the second quantization of the parameters (e.g., by obtaining a linear combination of the first and second quantization of the parameters).

Next, process 400 proceeds to block 408 where the system updates the architecture of the machine learning model using the indication of the architecture gradient. In some embodiments, the system may be configured to determine a descent for the architecture parameters using the indication of the architecture gradient. For example, the system may determine the descent to be a proportion (e.g., 0.1, 0.2, 0.5, or 1) of the indication of the architecture gradient. The system may be configured to update the architecture of the machine learning model by applying the descent. For example, the architecture search space may be parameterized as weights for respective architecture parameters. In this example, the system may apply the descent to the weights for the architecture parameters. Continuing with an example of a CNN, the architecture search space may be parameterized as weights for candidate operations that can be performed at each layer of the CNN (e.g., convolution, max pooling, and/or fully connected layer). The system may update the architecture of the CNN by updating the weights for the candidate operations.

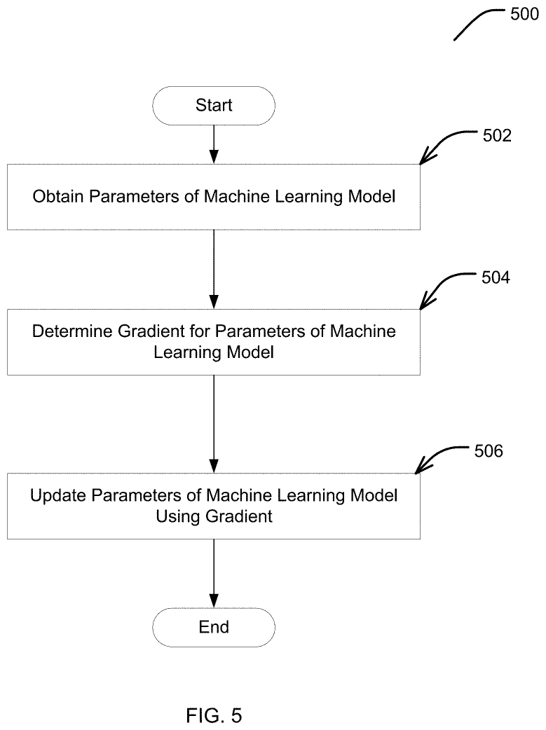

FIG. 5 shows a flowchart of an example process 500 for updating parameters of a machine learning model, according to some embodiments of the technology described herein. Process 500 may be performed as part of process 300 described herein with reference to FIG. 3. For example, process 500 may be performed as part of block 306 of process 300. In some embodiments, process 500 may be performed after performing process 400 to update the architecture of a machine learning model. Process 500 may be performed by any suitable computing device. For example, process 500 may be performed by training system 102 described herein with reference to FIG. 1.

Process 500 begins at block 502, where the system obtains parameters of a machine learning model. For example, the system may obtain the parameters by randomly initializing the parameters at the start of an iterative architecture search (e.g., process 300). In another example, the system may obtain the parameters of the machine learning model from a previously performed update of the parameters (e.g., in an iteration of an architecture search).

Next, process 500 proceeds to block 504, where the system determines a gradient for the parameters of the machine learning model. In some embodiments, the system may be configured to determine a gradient for the parameters by: (1) determining predicted outputs of a machine learning model (e.g., on a set of training data); (2) determining a difference between the predicted outputs of the machine learning model and expected outputs; and (3) determining the gradient based on the difference. In some embodiments, the system may be configured to evaluate the difference using a loss function. For example, the system may determine a partial derivative of a loss function with respect to the parameters to be the gradient.

Next, process 500 proceeds to block 508, where the system updates parameters of the machine learning model using the determined gradient. In some embodiments, the system may be configured to update the parameters of the machine learning model by descending the parameters by a proportion of the gradient. For example, the system may descend each parameter as a proportion (e.g., 0.1, 0.2, 0.3, 0.4, 0.5, 1.0) of a partial derivative of a loss function with respect to the parameter (e.g., determined using a training data set).

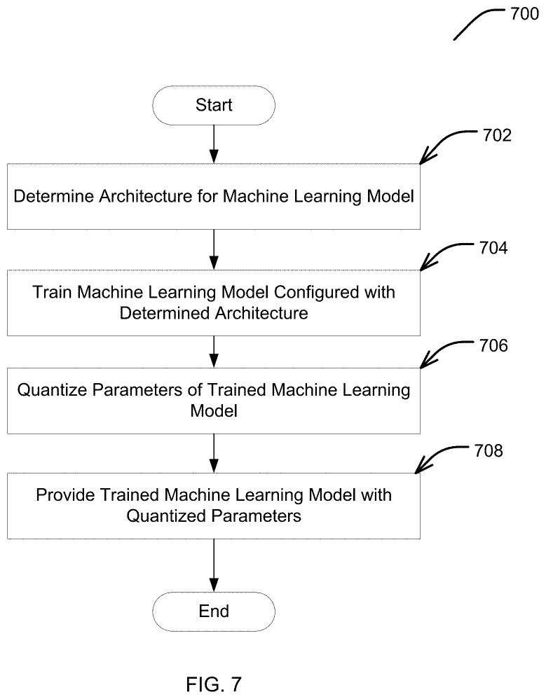

FIG. 6 shows a flowchart of an example process 600 for quantizing parameters of a machine learning model, according to some embodiments of the technology described herein. In some embodiments, process 600 may be performed as part of process 400 described herein with reference to FIG. 4. For example, process 600 may be performed at block 404 of process 400. In some embodiments, process 600 may be performed as part of process 700 described herein with reference to FIG. 7. For example, the process 600 may be performed at block 706 of process 700. Process 600 may be performed by any suitable computing device. For example, process 600 may be performed by training system 102 described herein with reference to FIG. 1.

Process 600 begins at block 602, where the system obtains a set of parameters of a machine learning model. The system may obtain the set of parameters of the machine learning model as described at block 402 of process 400. For example, the system may obtain the set of parameters by initializing the parameters at the start of an iterative process (e.g., process 300) to determine an optimal architecture of the machine learning model. In another example, the system may obtain the set of parameters from performing a previous iteration of a process for determining an optimal architecture of the machine learning model. In some embodiments, the system may be configured to obtain a set of parameters of a trained machine learning model. For example, the system may obtain a learned set of parameters obtained from applying a training algorithm to a set of training data.

Next, process 600 proceeds to block 604 where the system quantizes a parameter from the set of parameters of the machine learning model. In some embodiments, the system may be configured to quantize the parameter by transforming the parameter from a first representation to a second representation. For example, the first representation may be a floating point value. The system may be configured to quantize the parameter by transforming the floating point value to another representation. For example, the system may quantize the parameter by mapping the floating point value to an integer representation. In some embodiments, the first representation may be a first number of bits and the second representation may be a second number of bits. The system may be configured to transform the parameter from the first representation to the second representation by determining a representation of the parameter in the second number of bits. In some embodiments, the second number of bits may be smaller than the first number of bits. For example, the first representation may be 32 bits and the second representation may be 8 bits.

Next, process 600 proceeds to block 606 where the system determines whether the entire set of parameters of the machine learning model has been quantized. If the system determines that all the parameters have not been quantized, then process 600 proceeds to block 606 where the system quantizes another one of the set of parameters of the machine learning model. If the system determines that all the parameters have been quantized, then process 600 ends. Although process 600 is illustrated sequentially, in some embodiments, the set of parameters of the machine learning model may be quantized in parallel. For example, the system may quantize a first parameter of the machine learning model in parallel with a second parameter of the machine learning model.

FIG. 7 shows a flowchart of an example process 700 for providing a machine learning model with an architecture optimized for quantization of parameters of the machine learning model, according to some embodiments of the technology described herein. Process 700 may be performed by any suitable computing device. For example, process 700 may be performed by training system 102 described herein with reference to FIG. 1.

Process 700 begins at block 702, where the system determines an architecture for the machine learning model. For example, the system may determine an architecture of the machine learning model that optimizes the machine learning model by performing process 300 described herein with reference to FIG. 3. In some embodiments, the system may be configured to determine the architecture using a quantization of parameters of the machine learning model.

Next, process 700 proceeds to block 704, where the system trains the machine learning model configured with the determined architecture. In some embodiments, the system may be configured to train the machine learning model using a set of training data. For example, the system may apply a supervised learning technique to the training data to train the machine learning model. In some embodiments, the system may be configured to train the machine learning model using stochastic gradient descent. For example, the system may perform stochastic gradient descent on using the set of training data to train the machine learning model. In another example, the system may apply an unsupervised learning technique to the training data to train the machine learning model. In some embodiments, the system may be configured to train the machine learning model in conjunction with determining the architecture of the machine learning model. For example, the system may update parameters using the stochastic gradient descent during iterations of a process for determining the architecture of the machine learning model.

Next, process 700 proceeds to block 706 where the system quantizes parameters of the trained machine learning model. In some embodiments, the system may be configured to quantize the parameters as described in process 600 described herein with reference to FIG. 6. For example, the system may quantize a trained parameter by transforming the parameter to a representation that uses a fewer number of bits than the unquantized parameter (e.g., from a 32-bit representation to an 8-bit representation).

Next, process 700 proceeds to block 708 where the system provides the trained machine learning model with quantized parameters. In some embodiments, the system may be configured to provide the machine learning model to a device separate from the system. For example, the training server 202 may provide the machine learning model to a mobile device 204 through a network 206 (e.g., the Internet) as shown in FIG. 2. In some embodiments, the device may have more limited computational resources than the system performing process 700. For example, the system may have a processor with a 32-bit word size while the device may have a processor with an 8-bit word size. The trained machine learning model with quantized parameters may allow the device to use the machine learning model more efficiently than with unquantized parameters.

FIG. 8 shows a block diagram of an example computer system 800 that may be used to implement embodiments of the technology described herein. The computing device 800 may include one or more computer hardware processors 802 and non-transitory computer-readable storage media (e.g., memory 804 and one or more non-volatile storage devices 806). The processor(s) 802 may control writing data to and reading data from (1) the memory 804; and (2) the non-volatile storage device(s) 806. To perform any of the functionality described herein, the processor(s) 802 may execute one or more processor-executable instructions stored in one or more non-transitory computer-readable storage media (e.g., the memory 804), which may serve as non-transitory computer-readable storage media storing processor-executable instructions for execution by the processor(s) 802.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

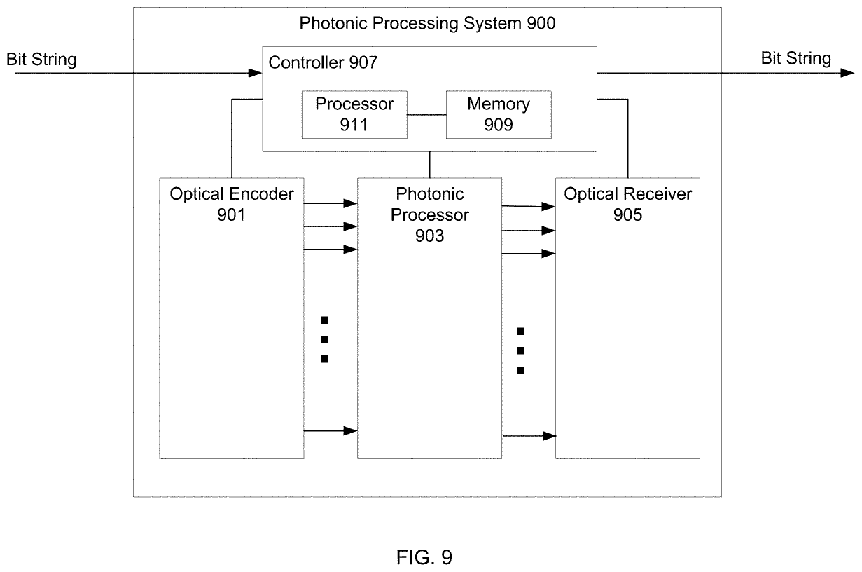

FIG. 9 shows a schematic diagram of an example photonic processing system 900, according to some embodiments of the technology described herein. Photonic processing system 900 may be used in a computing device. For example, photonic processing system 900 may be the processor 102A of training system 102 described herein with reference to FIG. 1. In another example, the photonic processing system 900 may be the processor 104A of device 104.

In some embodiments, photonic processing system 900 may be configured to determine an optical architecture of a machine learning model. For example, photonic processing system 900 may be configured to perform process 300 described herein with reference to FIG. 3. In some embodiments, the photonic processing system 900 may be configured to use a machine learning model, where an architecture of the machine learning model is selected from multiple candidate architectures using a quantization of parameters of the machine learning model. For example, the photonic processing system 900 may be configured to use a machine learning model obtained from performing process 300. The photonic processing system 900 may: (1) obtain a set of data; (2) generate, using the set of data, input to the machine learning model; and (3) provide the input to the machine learning model to obtain an output. The machine learning model may be a trained machine learning model. For example, the machine learning model may be a trained machine learning model obtained by performing process 700 described herein with reference to FIG. 7.

Referring to FIG. 9, a photonic processing system 900 includes an optical encoder 901, a photonic processor 903, an optical receiver 905, and a controller 907, according to some embodiments. The photonic processing system 900 receives, as an input from an external processor (e.g., a CPU), an input vector represented by a group of input bit strings and produces an output vector represented by a group of output bit strings. For example, if the input vector is an n-dimensional vector, the input vector may be represented by n separate bit strings, each bit string representing a respective component of the vector. The input bit string may be received as an electrical or optical signal from the external processor and the output bit string may be transmitted as an electrical or optical signal to the external processor. In some embodiments, the controller 907 may not necessarily output an output bit string after every process iteration. Instead, the controller 907 may use one or more output bit strings to determine a new input bit stream to feed through the components of the photonic processing system 900. In some embodiments, the output bit string itself may be used as the input bit string for a subsequent iteration of the process implemented by the photonic processing system 900. In some embodiments, multiple output bit streams are combined in various ways to determine a subsequent input bit string. For example, one or more output bit strings may be summed together as part of the determination of the subsequent input bit string.

In some embodiments, the optical encoder 901 may be configured to convert the input bit strings into optically encoded information to be processed by the photonic processor 903. In some embodiments, each input bit string is transmitted to the optical encoder 901 by the controller 907 in the form of electrical signals. The optical encoder 901 may be configured to convert each component of the input vector from its digital bit string into an optical signal. In some embodiments, the optical signal represents the value and sign of the associated bit string as an amplitude and a phase of an optical pulse. In some embodiments, the phase may be limited to a binary choice of either a zero phase shift or a π phase shift, representing a positive and negative value, respectively. Embodiments are not limited to real input vector values. Complex vector components may be represented by, for example, using more than two phase values when encoding the optical signal. In some embodiments, the bit string is received by the optical encoder 901 as an optical signal (e.g., a digital optical signal) from the controller 907. In these embodiments, the optical encoder 901 converts the digital optical signal into an analog optical signal of the type described above.

In some embodiments, the optical encoder 901 may be configured to output n separate optical pulses that are transmitted to the photonic processor 903. Each output of the optical encoder 901 is coupled one-to-one to a single input of the photonic processor 903. In some embodiments, the optical encoder 901 may be disposed on the same substrate as the photonic processor 903 (e.g., the optical encoder 901 and the photonic processor 903 are on the same chip). In such embodiments, the optical signals may be transmitted from the optical encoder 901 to the photonic processor 903 in waveguides, such as silicon photonic waveguides. In other embodiments, the optical encoder 901 may be disposed on a separate substrate from the photonic processor 903. In such embodiments, the optical signals may be transmitted from the optical encoder 901 to the photonic processor 103 in optical fiber.

In some embodiments, the photonic processor 903 may be configured to perform the multiplication of the input vector by a matrix M As described in detail below, the matrix M is decomposed into three matrices using a combination of a singular value decomposition (SVD) and a unitary matrix decomposition. In some embodiments, the unitary matrix decomposition is performed with operations similar to Givens rotations in QR decomposition. For example, an SVD in combination with a Householder decomposition may be used. The decomposition of the matrix M into three constituent parts may be performed by the controller 907 and each of the constituent parts may be implemented by a portion of the photonic processor 903. In some embodiments, the photonic processor 903 includes three parts: a first array of variable beam splitters (VBSs) configured to implement a transformation on the array of input optical pulses that is equivalent to a first matrix multiplication; a group of controllable optical elements configured to adjust the intensity and/or phase of each of the optical pulses received from the first array, the adjustment being equivalent to a second matrix multiplication by a diagonal matrix; and a second array of VBSs configured to implement a transformation on the optical pulses received from the group of controllable electro-optical element, the transformation being equivalent to a third matrix multiplication.

In some embodiments, the photonic processor 903 may be configured to output n separate optical pulses that are transmitted to the optical receiver 905. Each output of the photonic processor 903 is coupled one-to-one to a single input of the optical receiver 905. In some embodiments, the photonic processor 903 may be disposed on the same substrate as the optical receiver 905 (e.g., the photonic processor 903 and the optical receiver 905 are on the same chip). In such embodiments, the optical signals may be transmitted from the photonic processor 903 to the optical receiver 905 in silicon photonic waveguides. In other embodiments, the photonic processor 903 may be disposed on a separate substrate from the optical receiver 905. In such embodiments, the optical signals may be transmitted from the photonic processor 103 to the optical receiver 905 in optical fibers.

In some embodiments, optical receiver 905 receives the n optical pulses from the photonic processor 903. Each of the optical pulses is then converted to electrical signals. In some embodiments, the intensity and phase of each of the optical pulses is measured by optical detectors within the optical receiver. The electrical signals representing those measured values are then output to the controller 907.

As shown in the example embodiment of FIG. 9, controller 907 includes a memory 909 and a processor 911 for controlling the optical encoder 901, the photonic processor 903 and the optical receiver 905. The memory 909 may be used to store input and output bit strings and measurement results from the optical receiver 905. The memory 909 also stores executable instructions that, when executed by the processor 911, control the optical encoder 901, perform the matrix decomposition algorithm, control the VBSs of the photonic processor 103, and control the optical receivers 905. The memory 909 may also include executable instructions that cause the processor 911 to determine a new input vector to send to the optical encoder based on a collection of one or more output vectors determined by the measurement performed by the optical receiver 905. In this way, the controller 907 can control an iterative process by which an input vector is multiplied by multiple matrices by adjusting the settings of the photonic processor 903 and feeding detection information from the optical receiver 905 back to the optical encoder 901. Thus, the output vector transmitted by the photonic processing system 900 to the external processor may be the result of multiple matrix multiplications, not simply a single matrix multiplication.

In some embodiments, a matrix may be too large to be encoded in the photonic processor using a single pass. In such situations, one portion of the large matrix may be encoded in the photonic processor and the multiplication process may be performed for that single portion of the large matrix. The results of that first operation may be stored in memory 909. Subsequently, a second portion of the large matrix may be encoded in the photonic processor and a second multiplication process may be performed. This “chunking” of the large matrix may continue until the multiplication process has been performed on all portions of the large matrix. The results of the multiple multiplication processes, which may be stored in memory 909, may then be combined to form the final result of the multiplication of the input vector by the large matrix.

In other embodiments, only collective behavior of the output vectors is used by the external processor. In such embodiments, only the collective result, such as the average or the maximum/minimum of multiple output vectors, is transmitted to the external processor.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of determining an architecture of a machine learning model that optimizes the machine learning model, the method comprising:
using a processor to perform:
obtaining the machine learning model configured with a first architecture of a plurality of architectures, the machine learning model comprising a first set of parameters;
determining a second architecture of the plurality of architectures using a quantization of the first set of parameters; and
updating the machine learning model to obtain the machine learning model configured with the second architecture.

2. The method of claim 1, further comprising obtaining the quantization of the first set of parameters.

3. The method of claim 2, wherein:
each of the first set of parameters is encoded with a first representation; and
obtaining the quantization of the first set of parameters comprises, for each of the first set of parameters, transforming the parameter to a second number representation.

4. The method of claim 1, wherein determining the second architecture using the quantization of the first set of parameters comprises:
determining an indication of an architecture gradient using the quantization of first set of parameters; and
determining the second architecture using the indication of the architecture gradient.

5. The method of claim 4, wherein determining the indication of the architecture gradient for the first architecture comprises determining a partial derivative of a loss function using the quantization of the first set of parameters.

6. The method of claim 1, further comprising updating the first set of parameters of the machine learning model to obtain a second set of parameters.

7. The method of claim 6, wherein updating the first set of parameters comprises using gradient descent to obtain the second set of parameters.

8. The method of claim 1, further comprising encoding an architecture of the machine learning model as a plurality of weights for respective architecture parameters, the architecture parameters representing the plurality of architectures.

9. The method of claim 8, wherein:
determining the second architecture comprises determining an update to at least some weights of the plurality of weights; and
updating the machine learning model comprises applying the update to the at least some weights.

10. The method of claim 1, wherein determining the second architecture using the quantization of the first set of parameters comprises:
combining each of the first set of parameters with a respective quantization of the parameter to obtain a set of blended parameter values; and
determining the second architecture using the set of blended parameter values.

11. The method of claim 10, wherein combining the parameter with the quantization of the parameter comprises determining a linear combination of the parameter and the quantization of the parameter.

12. The method of claim 1, wherein the machine learning model comprises a neural network.

13. The method of claim 12, wherein the neural network comprises a convolutional neural network (CNN).

14. The method of claim 12, wherein the neural network comprises a recurrent neural network (RNN).

15. The method of claim 12, wherein the neural network comprises a transformer neural network.

16. The method of claim 1, further comprising training the machine learning model configured with the second architecture to obtain a trained machine learning model configured with the second architecture.

17. The method of claim 16, further comprising quantizing parameters of the trained machine learning model configured with the second architecture to obtain a machine learning model with quantized parameters.

18. The method of claim 17, wherein the processor has a first word size and the method further comprises transmitting the machine learning model with quantized parameters to a device comprising a processor with a second word size, wherein the second word size is smaller than the first word size.

19. A system for determining an architecture of a machine learning model that optimizes the machine learning model, the system comprising:
a processor;
a non-transitory computer-readable storage medium storing instructions that, when executed by the processor, cause the processor to perform a method comprising:
obtaining the machine learning model configured with a first one of a plurality of architectures, the machine learning model comprising a first set of parameters;
determining a second one of the plurality of architectures using a quantization of the first set of parameters; and
updating the machine learning model to obtain the machine learning model configured with the second architecture.

20. A non-transitory computer-readable storage medium storing instructions, wherein the instructions, when executed by a processor, cause the processor to perform a method comprising:
obtaining a machine learning model configured with a first one of a plurality of architectures, the machine learning model comprising a first set of parameters;
determining a second architecture the plurality of architectures using a quantization of the first set of parameters; and
updating the machine learning model to obtain the machine learning model configured with the second architecture.

21. A device comprising:
a processor;
a non-transitory computer-readable storage medium storing instructions that, when executed by the processor, cause the processor to perform a method comprising:
obtaining a set of data;
generating, using the set of data, an input to a trained machine learning model configured with an architecture selected from a plurality of architectures, wherein the architecture is selected from the plurality of architectures using a quantization of at least some parameters of the machine learning model; and
providing the input to the trained machine learning model to obtain an output.

23. The device of claim 21, wherein the processor has a first word size and the trained machine learning model is obtained by training a machine learning model using a processor with a second word size.

23. The device of claim 22, wherein the first word size is smaller than the second word size.

24. The device of claim 22, wherein the first word size is 8 bits.

25. The device of claim 21, wherein the processor comprises a photonics processing system.

26. The device of claim 21, wherein the trained machine learning model comprises a neural network.

27. The device of claim 25, wherein the neural network comprises a convolutional neural network, a recurrent neural network, and/or a transformer neural network.
